(19) United States
(12) Patent Application Publication
(10) Pub. No.: US 2025/0346317 A1
(43) Pub. Date: Nov. 13, 2025

(54) FENDER PROTECTOR FOR USE WITH MOTOCROSS MOTORCYCLES

(71) Applicant: Jeff Ward, Newport Beach, CA (US)

(72) Inventor: Jeff Ward, Newport Beach, CA (US)

(21) Appl. No.: 19/207,091

(22) Filed: May 13, 2025

Related U.S. Application Data
(60) Provisional application No. 63/646,606, filed on May 13, 2024.

(51) Int. Cl. B62J 15/02

(52) U.S. Cl. CPC B62J 15/02

(57) ABSTRACT

A fender protector for use with a motocross motorcycle is described herein. The fender protector includes a protector body, a front curved fastening member, and a rear curved fastening member. The protector body includes an arcuate outer surface extending between a front endwall and a rear endwall along a longitudinal. The front curved fastening member is coupled to a front portion of the protector body and includes a forward fastening pocket configured to receive a front end of a motorcycle fender. The rear curved fastening member is coupled to a rear portion of the protector body and includes a rear fastening pocket configured to receive a rear end of the motorcycle fender therein to facilitate coupling the rear end of the motorcycle fender to the rear portion of the fender protector via a friction fit.

### CROSS REFERENCE TO RELATED APPLICATIONS

This application claims the benefit of U.S. Provisional application Ser. No. 63/646,606 filed on May 13, 2024, the disclosures of which are hereby incorporated by reference in their entirety and for all purposes.

### TECHNICAL FIELD

This invention relates generally to motorcycles, and more specifically, to a fender protector for use with motocross motorcycles.

### BACKGROUND OF THE INVENTION

At least some known motorcycles include both front and rear fenders for use in protecting the rider and engine from dust and debris. However, when used for off highway use, such as off-road or motocross, mud, dirt, and debris may accumulate along the underside of the fenders. Because these fenders are not easily removed, cleaning the mud and debris from the underside of the fenders becomes difficult, which results in unwanted deposited of mud in storage areas when storing the motorcycle after use. In addition, during a motocross competition, the accumulation of mud along the underside of the fenders may reduce performance, maneuverability, and speed of the motorcycle. As such, there is a need to quickly remove mud and debris from the underside of the fender to improve performance during competition. The present invention addresses one or more of the aforementioned challenges.

### SUMMARY OF THE INVENTION

In one aspect of the present invention, a fender protector configured to be removably coupled to a motorcycle fender of a motocross motorcycle is provided. The fender protector includes a protector body, a front curved fastening member, and a rear curved fastening member. The protector body includes an arcuate outer surface extending between a front endwall and a rear endwall along a longitudinal axis and between a right sidewall and a left sidewall along a transverse axis. The front curved fastening member is coupled to a front portion of the protector body extending from the front endwall towards the rear endwall and includes a front curved fastening inner surface extending outwardly from the arcuate outer surface of the protector body to form a forward fastening pocket configured to receive a front end of the motorcycle fender therein to facilitate coupling the front end of the motorcycle fender to the front portion of the fender protector via a friction fit. The rear curved fastening member is coupled to a rear portion of the protector body extending from the rear endwall towards the front endwall and includes a rear curved fastening inner surface extending outwardly from the arcuate outer surface of the protector body to form a rear fastening pocket configured to receive a rear end of the motorcycle fender therein to facilitate coupling the rear end of the motorcycle fender to the rear portion of the fender protector via a friction fit.

In another aspect of the present invention, a motocross motorcycle is provided. The motocross motorcycle includes a motorcycle frame, a motorcycle fender coupled to the frame positioned above a motorcycle wheel, and a fender protector removably coupled to the motorcycle fender. The fender protector includes a protector body, a front curved fastening member, and a rear curved fastening member. The protector body includes an arcuate outer surface extending between a front endwall and a rear endwall along a longitudinal axis and between a right sidewall and a left sidewall along a transverse axis. The front curved fastening member is coupled to a front portion of the protector body extending from the front endwall towards the rear endwall and includes a front curved fastening inner surface extending outwardly from the arcuate outer surface of the protector body to form a forward fastening pocket configured to receive a front end of the motorcycle fender therein to facilitate coupling the front end of the motorcycle fender to the front portion of the fender protector via a friction fit. The rear curved fastening member is coupled to a rear portion of the protector body extending from the rear endwall towards the front endwall and includes a rear curved fastening inner surface extending outwardly from the arcuate outer surface of the protector body to form a rear fastening pocket configured to receive a rear end of the motorcycle fender therein to facilitate coupling the rear end of the motorcycle fender to the rear portion of the fender protector via a friction fit.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic view of a motorcycle including a fender protector, according to an embodiment of the present invention;

FIG. 2 is a side view of the fender protector;

FIGS. 3-5 are perspective views of a fender protector coupled to a motorcycle fender;

FIG. 6 is a top schematic view of the fender protector;

FIG. 7 is a bottom view of the fender protector; and

FIG. 8 is an illustration of coupling the fender protector to the underside of a motorcycle fender.

Corresponding reference characters indicate corresponding parts throughout the drawings.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

With reference to the drawings, and in operation, the present invention is directed towards a removable fender protector that is coupled to a motorcycle fender. The removable fender protector is sized and shaped to extend across the underside of the motorcycle fender to facilitate preventing mud and debris from adhering to the underside of the motorcycle. During use, mud and debris accumulates onto the underside of the fender protector, which can then be detached from the fender leaving the underside of the fender free from mud and debris. The fender protector can then be cleaned and reattached to the fender for continued use.

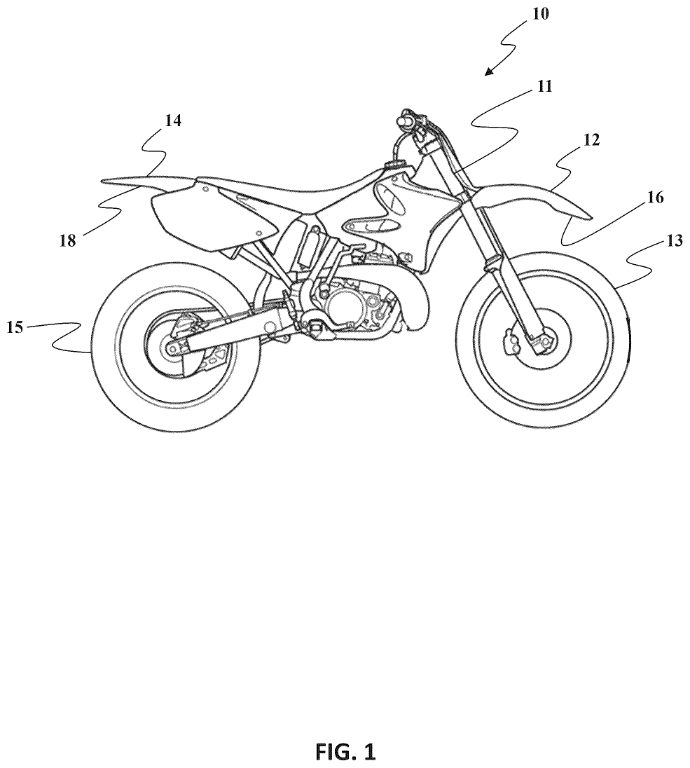

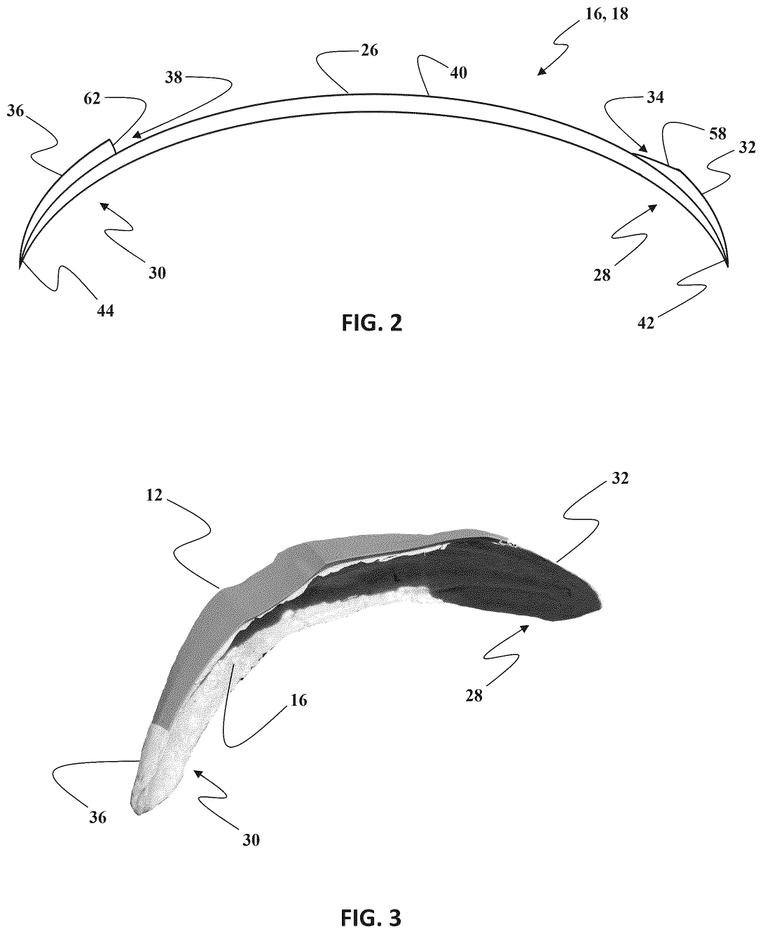

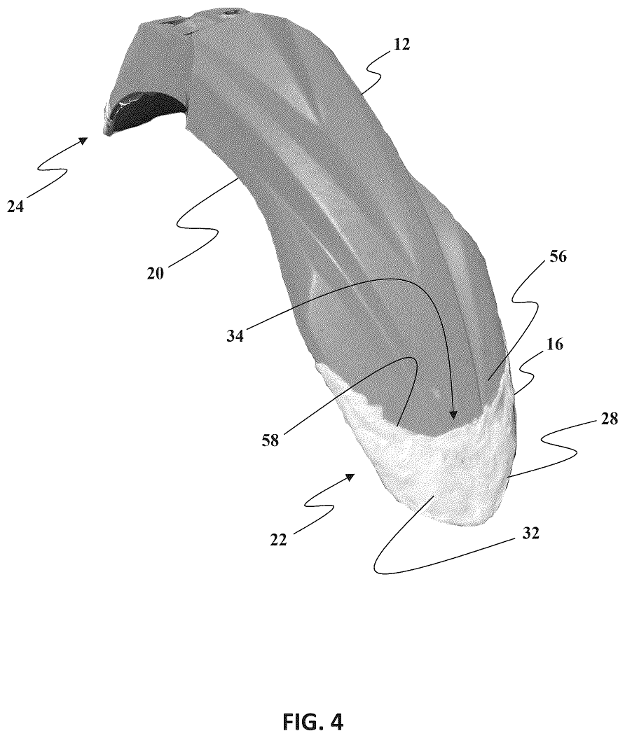

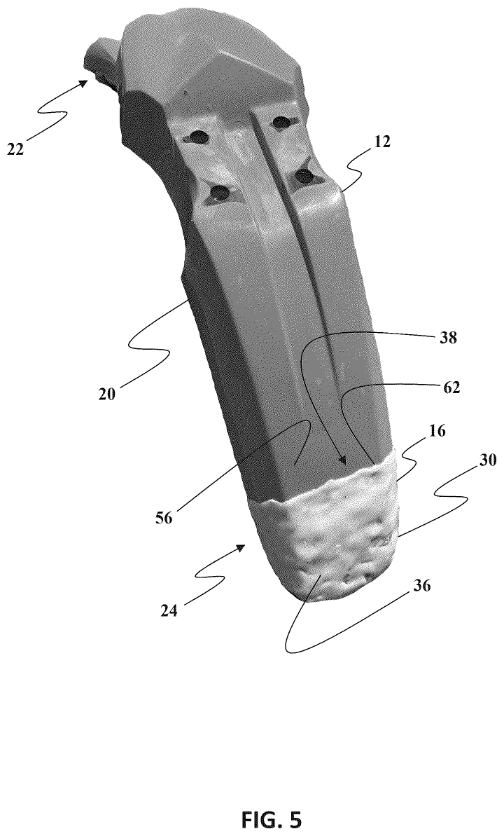

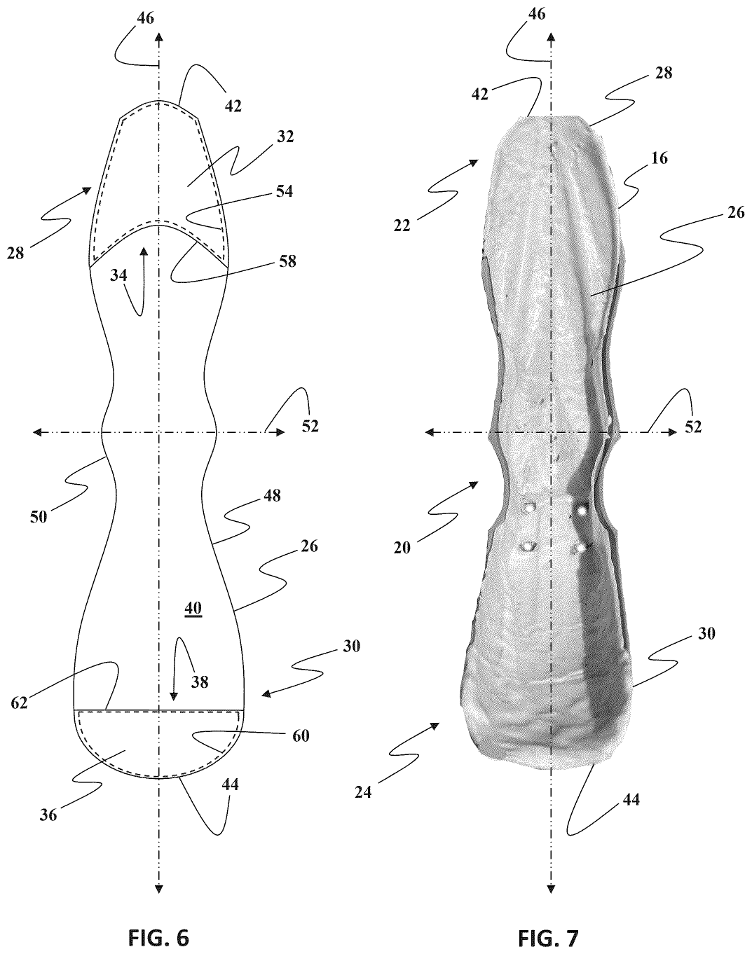

Referring to FIGS. 1-7, in the illustrated embodiment, the motocross motorcycle 10 includes a motorcycle frame 11, a front motorcycle fender 12 coupled to the motorcycle frame 11 positioned above a front motorcycle wheel 13, a rear motorcycle fender 14 coupled to the motorcycle frame 11 positioned above a rear motorcycle wheel 15, a front fender protector 16 removably coupled to the front motorcycle fender 12, and a rear fender protector 18 removable coupled to the rear motorcycle fender 14. Each motorcycle fender 12, 14 includes an arcuate fender body 20 that extends between a front end 22 and rear end 24.

Each fender protector 16, 18 includes an arcuate protector body 26 that extends between a front portion 28 and a rear portion 30. The front portion 28 includes a front curved fastening member 32 extending outwardly from an arcuate outer surface of the protector body 26 to form a forward fastening pocket 34 that is sized and shaped to receive the front end 22 of the fender therein to facilitate coupling the front end 22 of the fender to the front portion 28 of the fender protector via a friction fit.

Similarly, the rear portion 30 includes a rear curved fastening member 36 extending outwardly from the arcuate outer surface of the protector body 26 to form a rear fastening pocket 38 that is sized and shaped to receive the rear end 24 of the fender therein to facilitate coupling the rear end 24 of the fender to the rear portion 30 of the fender protector via a friction fit.

For example, in the illustrated embodiment, the fender protector 16, 18 includes the protector body 26 including an arcuate outer surface 40 extending between a front endwall 42 and a rear endwall 44 along a longitudinal axis 46, and between a right sidewall 48 and an opposite left sidewall 50 along a transverse axis 52 that is perpendicular to the longitudinal axis 46. The arcuate outer surface 40 of the protector body 26 is shaped substantially similar to an inner surface of the motorcycle fender such that the arcuate outer surface 40 of the protector body 26 extends across a full cross-sectional area of the inner surface of the motorcycle fender.

The front curved fastening member 32 is coupled to the front portion 28 of the protector body 26 and extends from the front endwall 42 towards the rear endwall 44 along the longitudinal axis 46. The front curved fastening member 32 includes a front curved fastening inner surface 54 that extends outwardly from the arcuate outer surface 40 of the protector body 26 to form the forward fastening pocket 34 that is sized and shaped to receive the front end 22 of the motorcycle fender therein. The front curved fastening inner surface 54 contacts an outer surface 56 of the front end 22 of the motorcycle fender when the front end 22 of a motorcycle fender is inserted within the forward fastening pocket 34.

In the illustrated embodiment, the front curved fastening member 32 includes an outer surface that is shaped substantially similar to the outer surface 56 of the front end 22 of the motorcycle fender. The front curved fastening member 32 also includes an arcuate forward edge 58 that extends between the right sidewall 48 and the left sidewall 50 of the protector body 26, and is spaced a distance from the arcuate outer surface 40 of the protector body 26 to define the open end of the forward fastening pocket 34. By providing the arcuate forward edge 58, the time required to install the fender protector over the motorcycle fender is significantly reduced, as the arcuate forward edge 58 facilitates feeding the leading edge of the front end 22 of the motorcycle fender into the open end of the forward fastening pocket 34

The rear curved fastening member 36 is coupled to the rear portion 30 of the protector body 26 and extends from the rear endwall 44 towards the front endwall 42 along the longitudinal axis 46. The rear curved fastening member 36 includes a rear curved fastening inner surface 60 that extends outwardly from the arcuate outer surface 40 of the protector body 26 to form the rear fastening pocket 38 that is sized and shaped to receive the rear end 24 of the motorcycle fender therein. The rear curved fastening inner surface 60 contacts an outer surface 56 of the rear end 24 of the motorcycle fender when the rear end 24 of the motorcycle fender is inserted within the rear fastening pocket 38.

In the illustrated embodiment, the rear curved fastening member 36 includes an outer surface that is shaped substantially similar to the outer surface 56 of the rear end 24 of the motorcycle fender. The rear curved fastening member 36 also includes a rear fastening edge 62 extending between the right sidewall 48 and the left sidewall 50 of the protector body 26 substantially parallel with the transverse axis 52, and is spaced a distance from the arcuate outer surface 40 of the protector body 26 to define the open end of the rear fastening pocket 38.

In some embodiments, the protector body 26, the front curved fastening member 32, and the rear curved fastening member 36 are formed as a unitary fender protector body 26 with the unitary fender protector body 26 formed of flexible plastic material that allows the unitary fender protector body 26 to bend during installation.

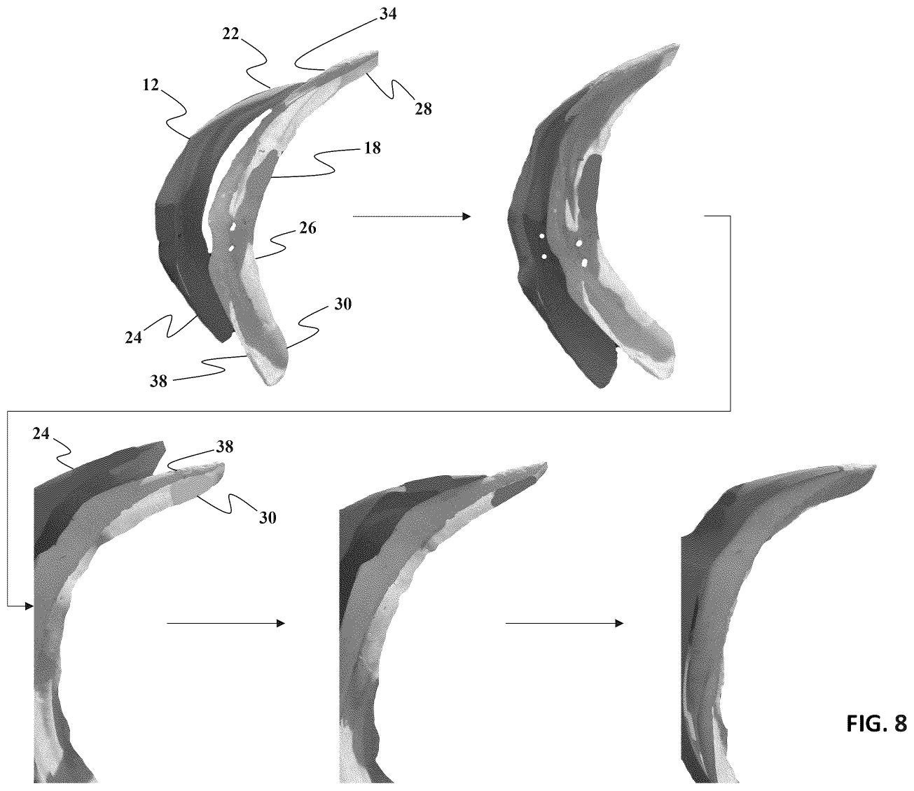

For example, as shown in FIG. 8, during installation, the front end 22 of the fender is first inserted into the forward fastening pocket 34 of the fender protector. The rear end 24 of the fender is then inserted into the rear fastening pocket 38 of the fender protector, and the protector body 26 is then pressed against the underside of the fender to couple the fender protector to the fender via a friction fit.

Obviously, many modifications and variations of the present invention are possible in light of the above teachings. The invention may be practiced otherwise than as specifically described within the scope of the appended claims.

Although specific features of various embodiments of the disclosure may be shown in some drawings and not in others, this is for convenience only. In accordance with the principles of the disclosure, any feature of a drawing or other embodiment may be referenced and/or claimed in combination with any feature of any other drawing or embodiment.

This written description uses examples to describe embodiments of the disclosure and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fender protector configured to be removably coupled to a motorcycle fender of a motocross motorcycle, comprising:
a protector body including an arcuate outer surface extending between a front endwall and a rear endwall along a longitudinal axis and between a right sidewall and a left sidewall along a transverse axis;
a front curved fastening member coupled to a front portion of the protector body extending from the front endwall towards the rear endwall and including a front curved fastening inner surface extending outwardly from the arcuate outer surface of the protector body to form a forward fastening pocket configured to receive a front end of the motorcycle fender therein to facilitate coupling the front end of the motorcycle fender to the front portion of the fender protector via a friction fit; and
a rear curved fastening member coupled to a rear portion of the protector body extending from the rear endwall towards the front endwall and including a rear curved fastening inner surface extending outwardly from the arcuate outer surface of the protector body to form a rear fastening pocket configured to receive a rear end of the motorcycle fender therein to facilitate coupling the rear end of the motorcycle fender to the rear portion of the fender protector via a friction fit.

2. The fender protector of claim 1, wherein the arcuate outer surface of the protector body is shaped substantially similar to an inner surface of the motorcycle fender to extend across a full cross-sectional area of the inner surface of the motorcycle fender.

3. The fender protector of claim 2, wherein the front curved fastening inner surface contacts an outer surface of the front end of the motorcycle fender with the front end of a motorcycle fender inserted within the forward fastening pocket.

4. The fender protector of claim 3, wherein the front curved fastening member includes an outer surface shaped substantially similar to the outer surface of the front end of the motorcycle fender.

5. The fender protector of claim 4, wherein the front curved fastening member includes an arcuate forward edge extending between the right sidewall and the left sidewall and spaced a distance from the arcuate outer surface of the protector body to define an open end of the forward fastening pocket.

6. The fender protector of claim 3, wherein the rear curved fastening inner surface contacts an outer surface of the rear end of the motorcycle fender with the rear end of the motorcycle fender inserted within the rear fastening pocket.

7. The fender protector of claim 6, wherein the rear curved fastening member includes an outer surface shaped substantially similar to the outer surface of the rear end of the motorcycle fender.

8. The fender protector of claim 7, wherein the rear curved fastening member includes a rear fastening edge extending between the right sidewall and the left sidewall substantially parallel with the transverse axis and spaced a distance from the arcuate outer surface of the protector body to define an open end of the rear fastening pocket.

9. The fender protector of claim 1, wherein the protector body, the front curved fastening member, and the rear curved fastening member are formed as a unitary fender protector body.

10. The fender protector of claim 9, wherein the unitary fender protector body is formed of flexible plastic material.

11. A motocross motorcycle, comprising:
a motorcycle frame;
a motorcycle fender coupled to the motorcycle frame positioned above a motorcycle wheel; and
a fender protector removably coupled to the motorcycle fender and including:
a protector body including an arcuate outer surface extending between a front endwall and a rear endwall along a longitudinal axis and between a right sidewall and a left sidewall along a transverse axis;
a front curved fastening member coupled to a front portion of the protector body extending from the front endwall towards the rear endwall and including a front curved fastening inner surface extending outwardly from the arcuate outer surface of the protector body to form a forward fastening pocket configured to receive a front end of the motorcycle fender therein to facilitate coupling the front end of the motorcycle fender to the front portion of the fender protector via a friction fit; and
a rear curved fastening member coupled to a rear portion of the protector body extending from the rear endwall towards the front endwall and including a rear curved fastening inner surface extending outwardly from the arcuate outer surface of the protector body to form a rear fastening pocket configured to receive a rear end of the motorcycle fender therein to facilitate coupling the rear end of the motorcycle fender to the rear portion of the fender protector via a friction fit.

12. The motocross motorcycle of claim 11, wherein the arcuate outer surface of the protector body is shaped substantially similar to an inner surface of the motorcycle fender to extend across a full cross-sectional area of the inner surface of the motorcycle fender.

13. The motocross motorcycle of claim 12, wherein the front curved fastening inner surface contacts an outer surface of the front end of the motorcycle fender with the front end of a motorcycle fender inserted within the forward fastening pocket.

14. The motocross motorcycle of claim 13, wherein the front curved fastening member includes an outer surface shaped substantially similar to an outer surface of the front end of the motorcycle fender.

15. The motocross motorcycle of claim 14, wherein the front curved fastening member includes an arcuate forward edge extending between the right sidewall and the left sidewall and spaced a distance from the arcuate outer surface of the protector body to define an open end of the forward fastening pocket.

16. The motocross motorcycle of claim 13, wherein the rear curved fastening inner surface contacts an outer surface of the rear end of the motorcycle fender with the rear end of the motorcycle fender inserted within the rear fastening pocket.

17. The motocross motorcycle of claim 16, wherein the rear curved fastening member includes an outer surface shaped substantially similar to the outer surface of the rear end of the motorcycle fender.

18. The motocross motorcycle of claim 17, wherein the rear curved fastening member includes a rear fastening edge extending between the right sidewall and the left sidewall substantially parallel with the transverse axis and spaced a distance from the arcuate outer surface of the protector body to define an open end of the rear fastening pocket.

19. The motocross motorcycle of claim 11, wherein the protector body, the front curved fastening member, and the rear curved fastening member are formed as a unitary fender protector body.

20. The motocross motorcycle of claim 19, wherein the unitary fender protector body is formed of flexible plastic material.
